(19) United States
(12) Patent Application Publication
(10) Pub. No.: US 2017/0220819 A1
(43) Pub. Date: Aug. 3, 2017

(54) INFORMATION EXCHANGE GATEWAY

(71) Applicant: HEWLETT PACKARD ENTERPRISE DEVELOPMENT LP, Houston, TX (US)

(72) Inventors: Chandra KAMALAKANTHA, Plano, TX (US); Parag DOSHI, Marietta, GA (US)

(73) Assignee: HEWLETT PACKARD ENTERPRISE DEVELOPMENT LP, Houston, TX (US)

(21) Appl. No.: 15/306,349

(22) PCT Filed: Aug. 12, 2014
(86) PCT No.: PCT/US2014/050728

§ 371 Date: Oct. 24, 2016

(51) Int. Cl. G06F 21/62; H04L 29/06

(52) U.S. Cl. CPC G06F 21/6263; H04L 63/0428; H04L 63/108

(57) ABSTRACT

Example implementations relate to an information exchange gateway. For example, a computing device may include a processor. The processor may receive a request to provide specified information to a requesting entity. The specified information may be associated with a user of the information exchange gateway managing information of the user. The processor may verify that the requesting entity is authorized by the user to receive the specified information. The processor may identify a source entity managing the specified information and may access the specified information from the source entity using an identifier identifying the user with respect to the source entity. The processor may provide the specified information to the requesting entity.

### BACKGROUND

Many people are faced with the mundane task of filling out forms for various reasons. For example, parents may be faced with filling out forms related to certain activities for their children, such as school-related forms, medical forms, summer camp forms, excuse forms, and the like.

### BRIEF DESCRIPTION OF THE DRAWINGS

Some examples of the present application are described with respect to the following figures:

FIG. 1 is a block diagram of an example computing device for providing information requested by a requesting entity;

FIG. 2 is a flowchart illustrating an example method of providing information requested by a requesting entity;

FIG. 3 is a block diagram of an example system of providing information to a requesting entity through an information exchange gateway;

FIG. 4 is block diagram of an example system of providing information to a requesting entity through an application user interface of an information exchange gateway; and

FIG. 5 is an interface diagram of an example user interface of an information exchange gateway.

### DETAILED DESCRIPTION

As described above, many people are faced with the task of filling out forms for various reasons, which may become tedious and repetitive. Information submitted on a form may come from various sources in various formats, such as from a doctor's office in the form of medical records.

An information exchange gateway may be used to dynamically access user information from various source entities such that the user information may be shared with various requesting entities that are appropriately authorized to receive the user information. A source entity may be any entity storing and managing information associated with a user, such as a doctor's office storing and managing medical records of a user. A requesting entity may be any entity requesting information associated with a user, such as a school requesting information about a user. For example, a school may request vaccination information for a student registering at the school, and a parent may use the information exchange gateway to provide the vaccination information to the school in various ways, such as by accessing the vaccination information from a doctor's office through the information exchange gateway, authorizing the exchange of vaccination information between the doctor's office and the school, and the like. While examples of the information exchange gateway are described throughout in the context of family-related forms, one of ordinary skill in the art will appreciate that the information exchange gateway may be used in any suitable context (e.g., providing and/or requesting information in a business context).

A user may register and create an account with the information exchange gateway. For example, a parent may register and create an account with the information exchange gateway to allow the information exchange gateway to manage access to and/or transfer of information related to the parent and the parent's family members. When creating an account, the user may provide information that may be associated with the user and any additional people related to the account. The information provided by the user may be any relevant information, such as names of people related to the account, date(s) of birth, contact information, any known medical information, and the like.

In some examples, the user may specify any source entities that may have additional information about the user and the people associated with the user. For example, the user may specify a particular doctor's office associated with a person related to the account. In some examples, the user may also provide any identifying information associated with the source entity, such as a patient identifier used to identify a patient with the particular doctor's office. In some examples, a user may associate data from other entities by dereferencing the data through an object field described in the ontology associated with the information exchange gateway.

In some examples, the user may authorize a particular requesting entity to receive specified information about a person associated with the account. For example, a user may authorize and request that vaccination information be sent from the doctor's office to a particular school. In some examples, the user may specify an expiration date associated with a particular request to send specified information to a particular requesting entity. For example, the user may indicate that a school is authorized to receive vaccination information until a particular expiration date.

A requesting entity may request information from a user in various ways. In some examples, a requesting entity may submit a request for information outside of the information exchange gateway. For example, the requesting entity may provide an oral or written request for a particular piece of information, and the user may use the information exchange gateway to request that the particular piece of information be sent to the requesting entity. In some examples, a requesting entity may use the information exchange gateway to submit a request for information. For example, the requesting entity may register and create an account with the information exchange gateway, and the requesting entity may then use the information exchange gateway to request a particular piece of information from the user. The user may receive a notification about this request through a user interface associated with the information exchange gateway and may authorize a source entity to provide the requested information to the requesting entity. In some examples, the user may pre-approve the requesting entity to receive the particular piece of information requested, and the information may be automatically provided to the requesting entity after a request for the information is received from the requesting entity.

In some examples, the information exchange gateway may maintain a context graph that may be used to learn the context of requests and/or information. A context graph may be maintained and used to determine various terminology that may refer to the same and/or similar requests and/or data. For example, a requesting entity may request information related to a user's previous booster shots, and a context graph may be used to determine that the requesting entity is requesting information related to vaccinations, immunizations, inoculations, and the like.

Once the information exchange gateway determines that a particular requesting entity has been authorized by the user to receive the information specified in the request, the information exchange gateway may determine the appropriate source entity maintaining the requested information and may access the information from the appropriate source entity. The information is accessed dynamically after the request is received and authorized such that current information is accessed and provided to the requesting entity, which may prevent data staleness. As such, information from source entities is not stored on the information exchange gateway. The information that is accessed and sent to the requesting entity may be encrypted and/or decrypted in any manner. The information exchange gateway may access the requested information from a source entity using an identifier associated with the user with respect to the source entity (e.g., a patient identifier used by the source entity to identify the user). The information accessed may be in any suitable form, such as structured data (e.g., a spreadsheet, a database format, etc.), unstructured data (e.g., a document, an email, etc.), a web feed service (e.g., RSS), and the like.

The requested information accessed from the source entity may be sent by the information exchange gateway to the requesting entity in any suitable manner and in any suitable format. In some examples, the requesting entity may be provided with a key that may be used to decrypt encrypted information from a source entity. In some examples, the requested information may be associated with an expiration date, and the information may be securely and automatically destroyed on the expiration date. In some examples, the information may be prevented from being copied and/or printed.

In some examples, inference engines may be used to dynamically establish and discover relationships between information and may be used to create and manage the context graphs described above. For example, if an address change is made by a user at the information exchange gateway, an inference engine of the information exchange gateway may determine that addresses with other entities are to be updated accordingly and may remind the user to update the addresses.

In some examples, the information exchange gateway uses the Resource Description Framework (RDF), which is a metadata data model that may be used for conceptual description or modeling of information in web resources to decompose data to smaller components with rules about semantics. The information exchange gateway may use RDF to maintain a metadata data model associated with various source entities. The RDF metadata data model of the information exchange gateway may be used to access user information from the source entities.

In some examples, the information exchange gateway may also use the Web Ontology Language (OWL), which is a family of knowledge representation languages (e.g., ontology languages) for authoring ontologies or knowledge bases. The information exchange gateway may use OWL to access information, such as relationship information between users and source entities, various record information (e.g., student records, patient medical records, patient identifiers, etc.), expiration dates, encryption key pairs, and the like.

In some examples, the information exchange gateway may use Simple Protocol and RDF Query Language (SPARQL), which is an RDF query language capable of accessing, retrieving, and modifying data stored in databases in RDF format. The information exchange gateway may use SPARQL to query distributed information about information technology assets for source entities, where the results of the query may include universal resource identifiers (URIs) that may be browsed and dereferenced by an application user interface of the information exchange gateway. The information exchange gateway may use the queried information technology asset information to generate and store a metadata RDF model based on the RDF models from the various source entities accessed. The metadata RDF model may be used to dynamically access requested user information at the source entities. This approach may allow the requested user information to be accessed without having to store the user information or the information technology asset information for various source entities at the information exchange gateway.

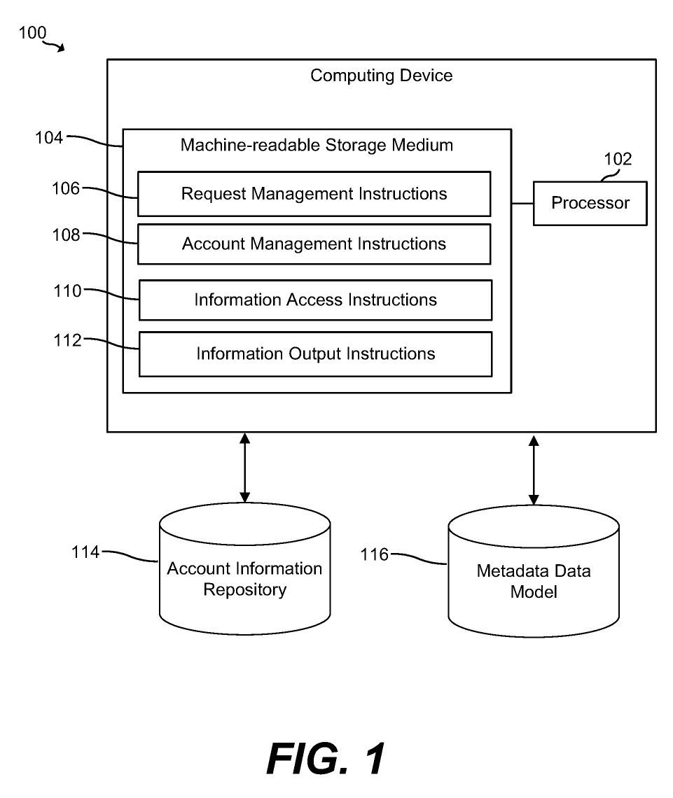

Referring now to the figures, FIG. 1 is a block diagram of an example computing device for providing information requested by a requesting entity. As used herein, a requesting entity may be any entity (e.g., a school) requesting information about another entity (e.g., a student).

Computing device 100 may be, for example, a web-based server, a local area network server, a cloud-based server, a notebook computer, a desktop computer, an all-in-one system, a tablet computing device, a mobile phone, an electronic book reader, a printing device, or any other electronic device suitable for performing the operations of an information exchange gateway, such as providing information requested by a requesting entity. Computing device 100 may include a processor 102 and a machine-readable storage medium 104. Computing device 100 may manage and control account information stored in account information repository 114 for various users of the information exchange gateway and may access and provide information using various metadata data model 116.

Processor 102 may be a central processing unit (CPU), a semiconductor-based microprocessor, and/or other hardware devices suitable for retrieval and execution of instructions stored in machine-readable storage medium 104. Processor 102 may fetch, decode, and execute instructions 106, 108, 110, and 112 to control a process of providing information requested by a requesting entity. As an alternative or in addition to retrieving and executing instructions, processor 102 may include at least one electronic circuit that includes electronic components for performing the functionality of instructions 106, 108, 110, 112, or a combination thereof.

Machine-readable storage medium 104 may be any electronic, magnetic, optical, or other physical storage device that contains or stores executable instructions. Thus, machine-readable storage medium 104 may be, for example, Random Access Memory (RAM), an Electrically Erasable Programmable Read-Only Memory (EEPROM), a storage device, an optical disc, and the like. In some examples, machine-readable storage medium 104 may be a non-transitory storage medium, where the term “non-transitory” does not encompass transitory propagating signals. As described in detail below, machine-readable storage medium 104 may be encoded with a series of processor executable instructions 106, 108, 110, and 112 for receiving a request to provide to a requesting entity specified information associated with a user of the information exchange gateway, verifying that the requesting entity is authorized by the user to receive the specified information, identifying a source entity managing the specified information, accessing the specified information from the source entity using an identifier identifying the user with respect to the source entity, and providing the specified information to the requesting entity.

Request management instructions 106 may manage and control requests to provide information requested by a requesting entity. Request management instructions 106 may receive the request from a user of the information exchange gateway or from a requesting entity requesting the information through the information exchange gateway. The request may be communicated from the user and/or the requesting entity to the information exchange gateway directly or over a network, which may be any suitable network. In various examples, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Account management instructions 108 may manage and control account information for users, source entities, and/or requesting entities associated with the information exchange gateway. Account management instructions 108 may access, collect, and obtain account information from users, source entities, and/or requesting entities associated with the information exchange gateway and store the account information in account information repository 114, which may be one or more storage devices storing the account information for users, source entities, and/or requesting entities. The account information may include any information associated with users, source entities, and/or requesting entities, such as contact information, people associated with each account, security information, settings and/or preferences (e.g., expiration dates, privacy settings, etc.), contacts and/or relationships between users and other entities, the type or characteristic of the information managed by each source entity, source entity identifiers, and the like.

Information access instructions 110 may manage and control access to information at source entities. Information access instructions 110 may determine or verify whether a requesting entity is authorized to receive a particular piece of information from a source entity. Upon verification of authorization, information access instructions 110 may access the particular piece of information from the authorized source entity. The information may be accessed using any identifiers associated with a user with respect to the authorized source entity. Information access instructions 110 may access metadata data model 116, which may be used to access the information from a source entity. Metadata data model 116 may be an RDF metadata data model that may specify a framework of one or more source entities.

Information output instructions 112 may manage and control the output of the information accessed at the authorized source entity. Information output instructions 112 may manage and control the manner in which the information is provided and displayed to the requesting entity, including encryption of the information.

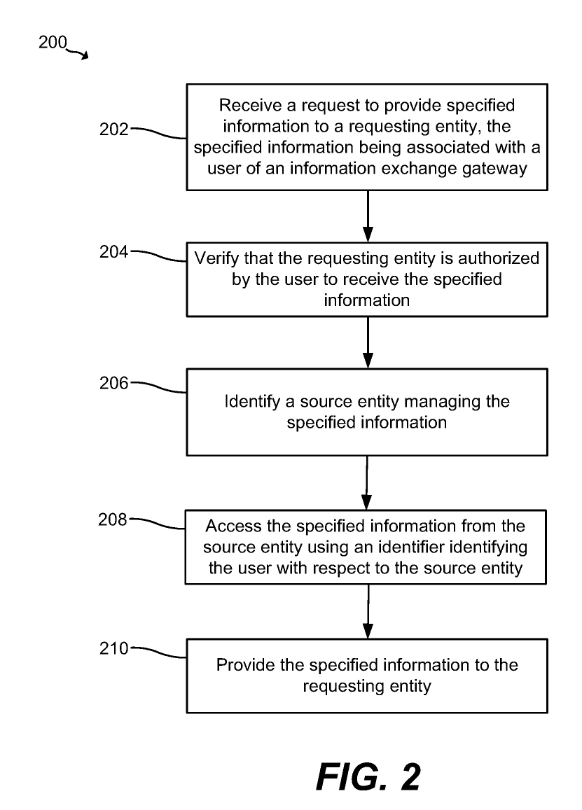

FIG. 2 is a flowchart illustrating an example method 200 of providing information requested by a requesting entity. Method 200 may be implemented using computing device 100 of FIG. 1.

Method 200 includes, at 202, receiving a request to provide specified information to a requesting entity. The specified information may be associated with a user of an information exchange gateway managed and controlled by computing device 100 of FIG. 1. For example, the request may be received from a user of the information exchange gateway or from a requesting entity requesting information about the user.

Method 200 also includes, at 204, verifying that the requesting entity is authorized by the user to receive the specified information. For example, a user may authorize the specified information as well as the requesting entity before the specified information may be sent to the requesting entity.

Method 200 also includes, at 206, identifying a source entity managing the specified information. For example, if a requesting entity is authorized to receive the specified information about a user, the information exchange gateway may determine and identify the appropriate source entity managing the specified information.

Method 200 also includes, at 208, accessing the specified information from the source entity using an identifier identifying the user with respect to the source entity. The information exchange gateway may access the identifier associated with the user with respect to the source entity and may use the identifier to access the specified information.

Method 200 also includes, at 210, providing the specified information to the requesting entity. The specified information may be provided in any suitable manner, such as through a user interface provided by the information exchange gateway.

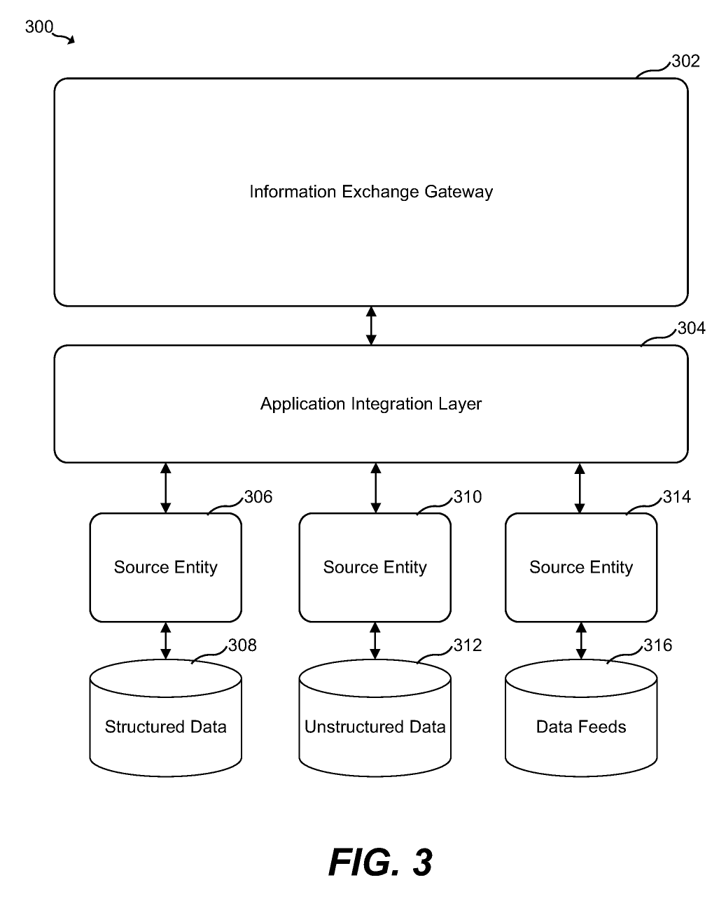

FIG. 3 is a block diagram of an example system 300 of providing information to a requesting entity through an information exchange gateway 302. The example system 300 may include the information exchange gateway 302, as previously described, and an application integration layer 304. Application integration layer 304 may be a software and/or hardware layer that may be used to interface with source entities, such as source entities 306, 310, and/or 314. As described above, source entities 306, 310, and/or 314 may include any entity storing and managing information associated with a user. The information stored and managed by a source entity may include any type of information. For example, source entity 306 may store and manage structured data 308 (e.g., data in a database), source entity 310 may store and manage unstructured data 312 (e.g., documents), and source entity 314 may store and manage data feeds 316 (e.g., RSS data feeds).

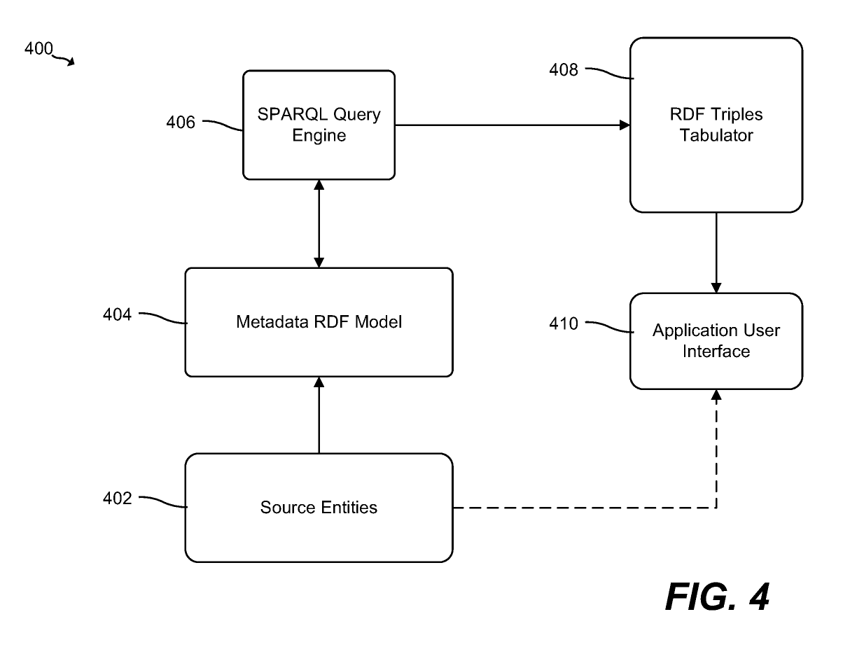

FIG. 4 is block diagram of an example system 400 of providing information to a requesting entity through an application user interface 410 of an information exchange gateway. The example system 400 includes one or more source entities 402, metadata RDF model 404, SPARQL query engine 406, RDF triples tabulator 408, and application user interface 410.

Source entities 402 may include one or more entities storing and managing information associated with a user, as described above. Information at source entities 402 may be accessed using metadata RDF model 404. SPARQL query engine 406 may query distributed information about information technology assets for source entities 402 and may use the queried information technology asset information to generate and store metadata RDF model 404 based on the RDF models from the source entities 402. Metadata RDF model 404 may be used to access information from each of the source entities 402.

Once information is accessed via SPARQL query engine 406 using metadata RDF model 404 to access the information from source entities 402, RDF triples tabulator 408 may be used to provide the requested information from source entities 402 to a user and/or a requesting entity. RDF triples tabulator 408 may manage and control the presentation of the requested information through application user interface 410.

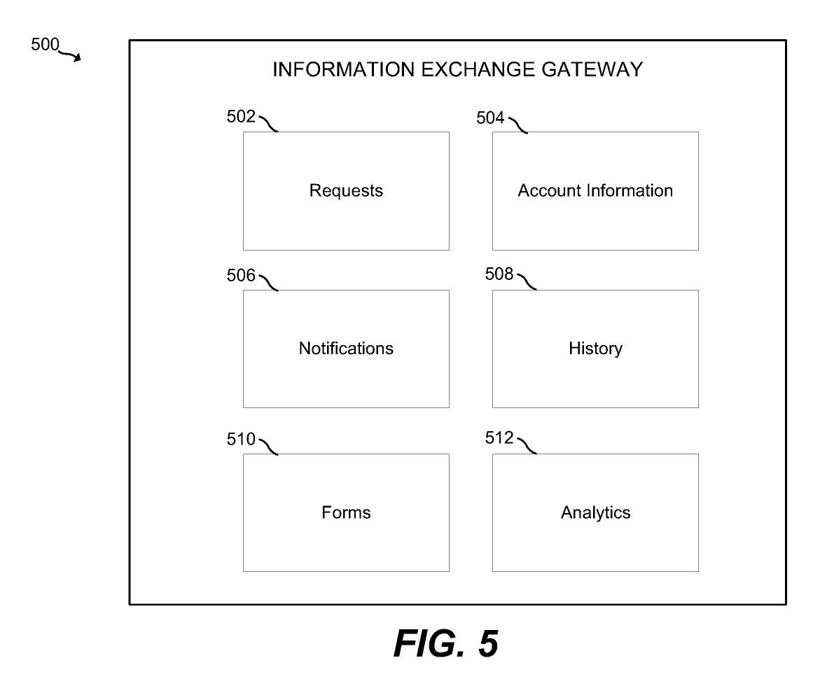

FIG. 5 is an interface diagram of an example user interface 500 of an information exchange gateway. User interface 500 may include a requests portion 502, an account information portion 504, a notifications portion 506, a history portion 508, a forms portion 510, and an analytics portion 512.

Requests portion 502 may be a portion of user interface 500 that may allow a user and/or a requesting entity to submit and/or view requests for information about a user. For example, requests portion 502 may allow a requesting entity to submit a request for information about a user of the information exchange gateway.

Account information portion 504 may be a portion of the user interface 500 that may allow a user and/or a requesting entity to submit and/or view account information associated with the user and/or the requesting entity. For example, a user may use account information portion 504 to submit and/or update contact information, user preferences, and the like.

Notifications portion 506 may be a portion of the user interface 500 that may notify a user and/or a requesting entity about the status of any requests for information. For example, notifications portion 506 may notify a user if a requesting entity has requested information about the user, and the user may authorize the requesting entity to receive the requested information accordingly.

History portion 508 may be a portion of the user interface 500 that may display any history data associated with a user and/or a requesting entity. For example, history portion 508 may display a user's history of information sent to various requesting entities.

Forms portion 510 may be a portion of the user interface 500 that may display any forms associated with a user and/or a requesting entity. For example, forms portion 510 may display a form that a user is to complete and may allow the form to be automatically populated or filled out by the user.

Analytics portion 512 may be a portion of the user interface 500 that may display any analytics associated with an account of a user and/or a requesting entity. For example, analytics portion 512 may display analytics associated with information requested and/or sent.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

1. A computing device comprising:
a processor to:
receive a request to provide specified information to a requesting entity, the specified information being associated with a user of an information exchange gateway managing information of the user;
verify that the requesting entity is authorized by the user to receive the specified information;
identify a source entity managing the specified information;
access the specified information from the source entity using an identifier identifying the user with respect to the source entity;
encrypt the specified information; and
provide the specified information to the requesting entity after the specified information is encrypted.

2. The computing device of claim 1, wherein the processor is further to receive an authorization from the user authorizing the requesting entity to receive the specified information.

3. (canceled)

4. The computing device of claim 1, wherein the request is received from the user.

5. The computing device of claim 1, wherein the request is received from the requesting entity.

6. The computing device of claim 1, wherein the processor is further to receive a registration request from the user to register an account with the information exchange gateway.

7. The computing device of claim 1, wherein the processor is further to receive a registration request from the requesting entity to register an account with the information exchange gateway.

8. The computing device of claim 1, wherein the processor is further to access a metadata data model specifying a framework of the source entity, the specified information being accessed using the metadata data model.

9. A method comprising:
receiving, by a computing device, a request to send specified information to a requesting entity, the specified information being associated with a user of an information exchange gateway managing information of the user;
determining, by the computing device, whether the requesting entity is authorized by the user to receive the specified information;
if the requesting entity is authorized by the user to receive the specified information:
accessing, by the computing device, the specified information from a source entity managing the specified information, the specified information being accessed using an identifier associated the user with respect to the source entity;
encrypting, by the computing device, the specified information; and
sending, by the computing device, the specified information to the requesting entity after the specified information is encrypted.

10. The method of claim 9, wherein the specified information is inaccessible by the requesting entity after a predetermined expiration date.

11. The method of claim 9, further comprising:
receiving, by the computing device, an authorization from the user authorizing the requesting entity to receive the specified information.

12. (canceled)

13. A non-transitory machine-readable storage medium storing instructions that, if executed by at least one processor of a computing device, cause the computing device to:
receive a request to provide specified information to a requesting entity, the specified information being associated with a user of an information exchange gateway managing information of the user;
identify that the requesting entity is authorized by the user to receive the specified information;
obtain the specified information from a source entity managing the specified information, the specified information being obtained using an identifier associated the user with respect to the source entity;
encrypt the specified information; and
provide the specified information to the requesting entity after the specified information is encrypted.

14. The non-transitory machine-readable storage medium of claim 13, wherein the instructions, if executed by the at least one processor, further cause the computing device to access a metadata data model specifying a framework of the source entity, the specified information being obtained using the metadata data model.

15. The non-transitory machine-readable storage medium of claim 13, wherein the specified information is inaccessible by the requesting entity after a predetermined expiration date.
